(19) United States
(12) Patent Application Publication
(10) Pub. No.: US 2009/0066482 A1
(43) Pub. Date: Mar. 12, 2009

(54) RADIO FREQUENCY IDENTIFICATION SYSTEM CAPABLE OF REDUCING POWER CONSUMPTION AND METHOD FOR OPERATING THE SAME

(76) Inventor: Yong-Wook Kim, Seoul (KR)

Correspondence Address: F. CHAU & ASSOCIATES, LLC, 130 WOODBURY ROAD, WOODBURY, NY, 11797, US

(21) Appl. No.: 12/205,268

(22) Filed: Sep. 5, 2008

(30) Foreign Application Priority Data
Sep. 6, 2007 (KR) 2007-90616

(51) Int. Cl. H04B 7/00

(52) U.S. Cl. 340/10.4

(57) ABSTRACT

An RFID system and a method for operating the same, in which the RFID system includes an RFID tag and an RFID reader. The RFID reader communicates with the RFID tag through a tag communication signal. The RFID reader transmits a tag sensing signal having a lower level power than the tag communication signal, senses the RFID tag entering a magnetic field created by the transmitted tag sensing signal on the basis of a current change due to a change in the magnetic field, and communicates with the sensed RFID tag.

### CROSS-REFERENCE TO RELATED APPLICATION

This U.S. non-provisional patent application claims priority under 35 U.S.C. §119 of Korean Patent Application No. 10-2007-0090616, filed on Sep. 6, 2007, the entire contents of which are hereby incorporated by reference.

### BACKGROUND OF THE INVENTION

The present disclosure relates to a Radio Frequency IDentification (RFID) system, and more particularly, to an RFID system capable of reducing power consumption.

Radio Frequency IDentification (RFID) is a technology that uses radio frequencies to transmit/receive information to/from an electronic tag attached to an object, thereby providing a related service during the sale of the object. The RFID can be thought of as a representative technology of general contactless cards that can replace barcodes, magnetic cards, IC cards, and the like.

The operating principle of the RFID system is as follows. An RFID system includes an RFID reader and an RFID tag. The RFID reader emits an active signal through an antenna to create an electromagnetic field, that is, an RF field. Upon entering the RF field, the RFID tag is enabled. In response to a reader request signal transmitted from the RFID reader, the enabled RFID tag transmits its stored information (or a tag response signal) to the RFID reader. Upon receiving the information from the RFID tag, the RFID reader analyzes the received information to obtain the specific information relating to an object to which the RFID tag is attached.

The RFID system is basically similar in function to a typical barcode reader system. In comparison with the barcode, however, the RFID system can store more information and also provide easy attachment to an object and can provide long-distance information communication. Also, because the RFID system uses radio frequencies to transmit the specific information about the object to which the RFID tag is attached, the RFID system is not adversely affected by environmental conditions such as snow, rain, wind, dust, and magnetic fields, and it can also sense a moving object. Also, because the RFID tag is given a unique ID at the manufacturing stage, the RFID system cannot be easily forged or tampered with.

A typical RFID reader continues to transmit a tag communication signal (or a tag communication power) for communication with an RFID tag. The tag communication signal includes a reader request signal. The reader request signal continues to be periodically transmitted until an RFID tag enters the RF field. For example, a bus card terminal including an RFID reader continues to periodically transmit a reader request signal. When a bus card to which an RFID tag is attached enters the RF field, the RFID tag transmits a tag response signal to the RFID reader in response to the reader request signal. Thereafter, the RFID reader continues to transmit the tag communication signal in order to sense the RFID tag.

As described above, the RFID reader continues to transmit the tag communication signal even when the RFID tag has not entered the RF field. Therefore, the conventional RFID system suffers from unnecessary power consumption.

### SUMMARY OF THE INVENTION

Exemplary embodiments of the present invention provide an RFID system capable of reducing power consumption and a method for operating the same.

Exemplary embodiments of the present invention provide RFID systems including: an RFID tag; and an RFID reader communicating with the RFID tag through a tag communication signal, wherein the RFID reader transmits a tag sensing signal having a lower level than the tag communication signal, senses the RFID tag entering an RF (magnetic field) created by the transmitted tag sensing signal on the basis of a current change due to a magnetic field change, and communicates with the sensed RFID tag.

In some exemplary embodiments, the tag sensing signal is activated/deactivated periodically, and the tag communication signal includes a reader request signal and a tag response signal.

In some exemplary embodiments, the RFID reader senses the RFID tag and then transmits the reader request signal to the RFID tag.

In some exemplary embodiments, the RFID tag transmits the tag response signal to the RFID reader in response to the reader request signal transmitted from the RFID reader.

In exemplary embodiments, the RFID reader includes: a controller controlling a transmitting/receiving operation; a transmitter generating the tag sensing signal or the reader request signal under the control of the controller; an antenna transmitting the tag sensing signal and the reader request signal; a receiver proving the controller with the tag response signal received through the antenna; and a tag sensor sensing the entry of the RFID tag into the RF field on the basis of a current change due to a magnetic field change at the antenna, wherein the controller controls the transmitter to generate the tag sensing signal or the reader request signal, according to the sensing result of the tag sensor.

In exemplary embodiments, the transmitter is disabled during an inactive period of the tag sensing signal under the control of the controller.

In exemplary embodiments, if the RFID tag has not yet entered the RF field, the controller controls the transmitter to generate the tag sensing signal only in response to a positive sensing result of the tag sensor.

In exemplary embodiments, when the RFID tag enters the RF field, the controller controls the transmitter to generate the reader request signal, in response to the sensing result of the tag sensor.

In exemplary embodiments, the antenna includes: a reader main antenna transmitting the tag sensing signal or transmitting/receiving the tag communication signal; and a tag sensing coil disposed parallel to the reader main antenna while being spaced apart from the reader main antenna by a predetermined distance, wherein the reader main antenna creates a magnetic field upon the transmission of the tag sensing signal, and the created magnetic field causes an induced current to flow through the tag sensing coil.

In exemplary embodiments, the tag sensing coil has a smaller diameter than the reader main antenna.

In exemplary embodiments, the RFID tag includes a tag antenna, and a magnetic field created in the reader main antenna is reduced by a magnetic field created in the tag antenna when the RFID tag enters the RF field.

In exemplary embodiments, the induced current flowing through the tag sensing coil is reduced by an amount corresponding to the magnetic field reduction, and the tag sensor senses the reduction in the amount of the induced current flowing through the tag sensing coil.

In exemplary embodiments of the present invention, methods for operating an RFID system include: transmitting a tag sensing signal having a lower level than a tag communication signal; sensing an RFID tag entering an RF field created by the transmitted tag sensing signal, on the basis of a current change due to a magnetic field change; and communicating with the sensed RFID tag.

In some exemplary embodiments, the tag sensing signal is activated/deactivated periodically.

### BRIEF DESCRIPTION OF THE FIGURES

The accompanying figures are included to provide a further understanding of exemplary embodiments of the present invention, and are incorporated in and constitute a part of this specification. The drawings illustrate exemplary embodiments of the present invention and, together with the description, serve to explain principles of the present invention. In the figures:

FIG. 1 is a block diagram of an RFID system according to an exemplary embodiment of the present invention;

FIG. 2 is a diagram illustrating an operating state of an antenna illustrated in FIG. 1 when an RFID tag does not enter an RF field;

FIG. 3 is a diagram illustrating an operating state of the antenna illustrated in FIG. 1 when the RFID tag enters the RF field;

FIG. 4 is a diagram illustrating a tag sensing signal and a tag communication signal according to an exemplary embodiment of the present invention; and

FIG. 5 is a flowchart illustrating an operation of the RFID system according to an exemplary embodiment of the present invention.

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be constructed as limited to the exemplary embodiments set forth herein. Rather, these exemplary embodiments are provided so that this disclosure will be thorough and complete, and will fully convey the scope of the present invention to those of ordinary skill in the art.

An RFID system in exemplary embodiments of the present invention includes an RFID tag and an RFID reader. When not communicating with the RFID tag, the RFID reader transmits a tag sensing signal that has a lower level than a tag communication signal used for communication with the RFID tag. The tag sensing signal is activated/deactivated periodically. The RFID reader includes a transmitter generating a transmit signal TX. The transmitter of the RFID reader is disabled during an inactive period of the tag sensing signal. Thus, the RFID system can reduce power consumption compared to conventional systems.

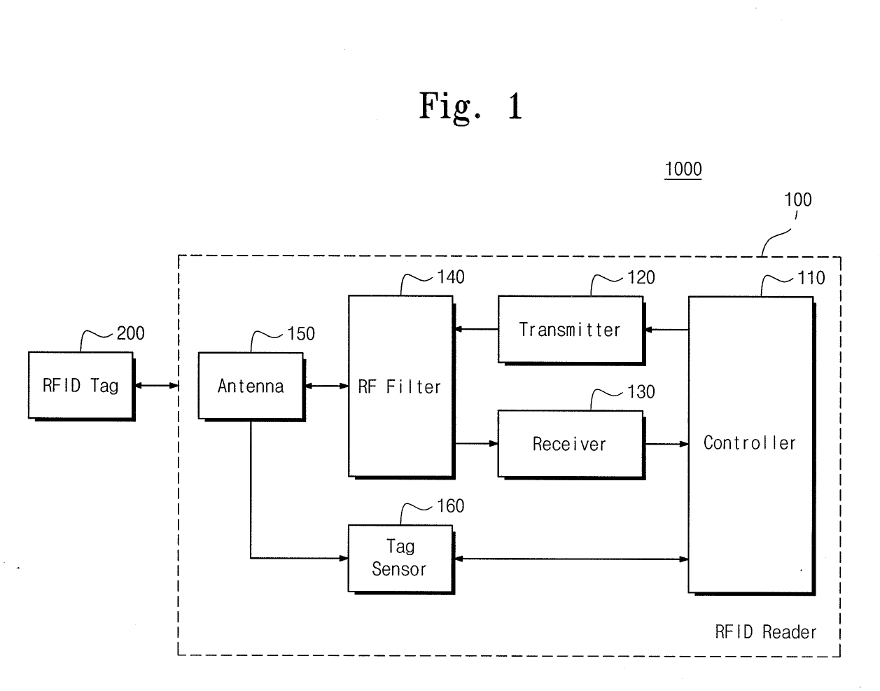

FIG. 1 is a block diagram of an RFID system according to an exemplary embodiment of the present invention.

Referring to FIG. 1, an RFID system 1000 includes an RFID reader 100 and an RFID tag 200. At an initial operation stage, the RFID reader 100 transmits a tag sensing signal (or a tag detection power) having a lower level power than a tag communication signal (or a tag communication power). When an RF (magnetic) field is created by the tag sensing signal and the RFID tag 200 enters the RF field, the RFID reader 100 senses the RFID tag 200. Upon sensing the RFID tag 200, the RFID reader 100 transmits a tag communication signal in order to communicate with the RFID tag 200.

The RFID reader 100 includes a controller 110, a transmitter 120, a receiver 130, an RF filter 140, an antenna 150, and a tag sensor 160.

The controller 110 controls an overall operation for communicating information with the RFID tag 200. The transmitter 120 generates a transmit (TX) signal, and the receiver 130 receives a receive (RX) signal. The controller 110 controls the generated TX signal to be transmitted to the RFID tag 200, and analyzes the received RX signal to obtain the information of the RFID tag 200. Also, before communication with the RFID tag 200, the controller 110 controls the transmitter 120 to generate a tag sensing signal having a lower level power than a tag communication signal.

Under the control of the controller 110, the transmitter 120 generates a TX signal with a predetermined frequency. The TX signal is filtered to a desired amplitude and frequency by the RF filter 140, and the filtered TX signal is transmitted through the antenna 150.

An RX signal transmitted from the RFID tag 200 is received through the antenna 150, and the received RX signal is filtered to a desired amplitude and frequency by the RF filter 140. The filtered RX signal is transferred to the receiver 130, and the receiver 130 demodulates the filtered RX signal to restore it to an original signal. The original signal is provided to the controller 110, and the controller 110 obtains the information of the RFID tag 200 from the original signal.

When the RFID tag 200 enters the RF field, the tag sensor 160 senses the entry of the RFID tag 200 into the RF field and transmits the sensing result to the controller 110. If the RFID tag 200 is not sensed by the tag sensor 160, the controller 110 controls the transmitter 120 to generate a tag sensing signal having a lower level power than a tag communication signal. On the other hand, if the RFID tag 200 is sensed by the tag sensor 160, the controller 110 controls the transmitter 120 to generate the tag communication signal in response to the sensing result.

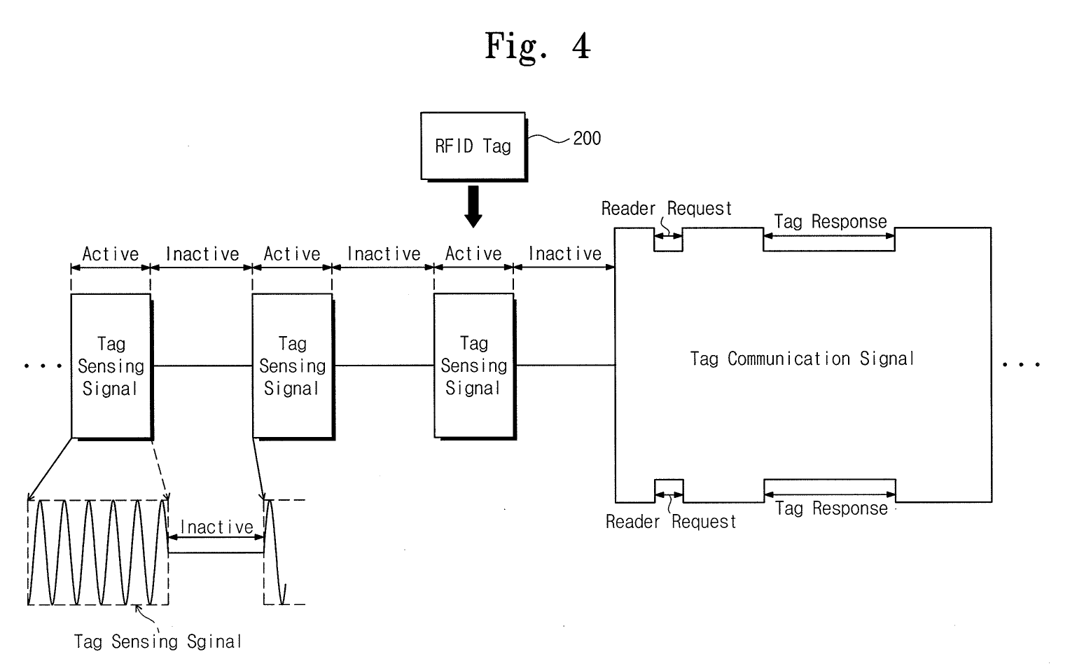

At the initial operation stage of the RFID reader 100, under the control of the controller 110, the transmitter 120 generates a tag sensing signal having a lower level power than a tag communication signal. The tag sensing signal is activated/deactivated periodically. That is, the tag sensing signal is generated periodically, and the transmitter 120 is disabled during a non-generation period of the tag sensing signal under the control of the controller 110, which will be described below in detail with reference to FIG. 4. Also, the tag sensor 160 is disabled during the non-generation period of the tag sensing signal under the control of the controller 110, which will also be described below in detail with reference to FIG. 4. The tag sensing signal is filtered by the RF filter 140, and the filtered tag sensing signal is transmitted through the antenna 150. An RF field is created by the tag sensing signal being transmitted through the antenna 150.

The tag sensor 160 senses a current change due to a change in the magnetic field at the antenna 150. On the other hand, when the RFID tag 200 does not enter the RF field, the magnetic field of the antenna 150 does not change. In this case, the tag sensor 160 provides a deactivated sensing signal to the controller 110. In response to the deactivated sensing signal, the controller 110 controls the transmitter 120 to generate a tag sensing signal of a lower power level.

On the other hand, when the RFID tag 200 enters the RF field, the magnetic field of the antenna 150 is changed. In this case, the tag sensor 160 senses a current change due to a change in the magnetic field of the antenna 150, and thus provides an activated sensing signal to the controller 110. In response to the activated sensing signal, the controller 110 controls the transmitter 120 to generate a tag communication signal. The generated tag communication signal is filtered by the RF filter 140, and the filtered tag communication signal is transmitted through the antenna 150 to the RFID tag 200. In this exemplary embodiment, the transmitted tag communication signal includes a reader request signal. In response to the reader request signal, the RFID tag 200 transmits its stored information, hereinafter referred to as a tag response signal, to the RFID reader 100. The antenna 150 of the RFID reader 100 receives the tag response signal from the RFID tag 200. The received tag response signal is filtered by the RF filter 140, and the filtered tag response signal is provided through the receiver 130 to the controller 110.

As a result, when not communicating with the RFID tag 200, the RFID reader 100 transmits the tag sensing signal having a lower level power than the tag communication signal. Thus, the RFID system 1000 can reduce power consumption.

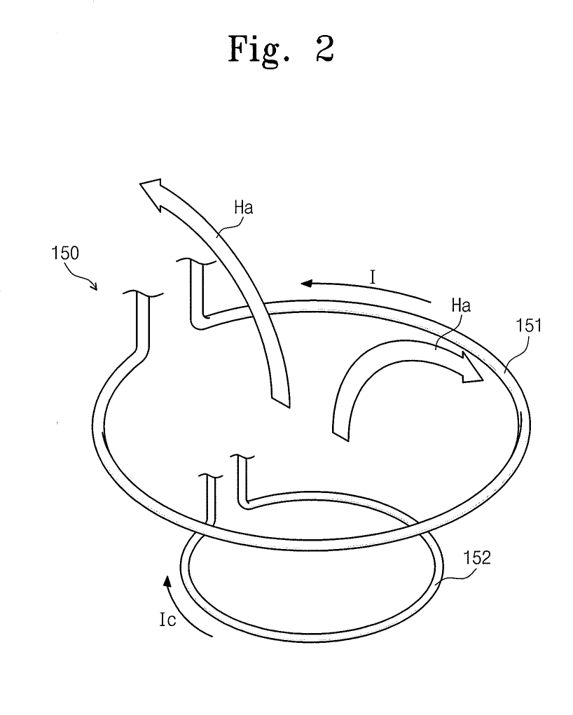

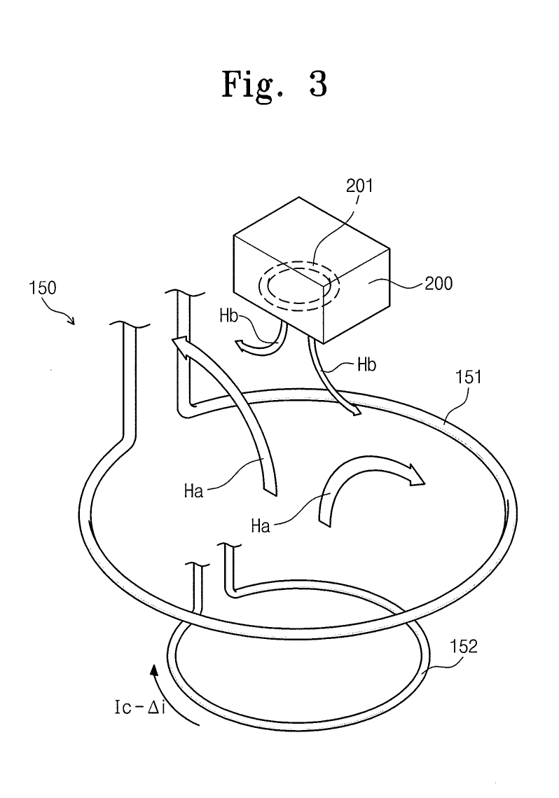

FIG. 2 is a diagram illustrating an operating state of the antenna illustrated in FIG. 1 when the RFID tag does not enter the RF field. FIG. 3 is a diagram illustrating an operating state of the antenna illustrated in FIG. 1 when the RFID tag does enter the RF field.

Referring to FIGS. 2 and 3, the antenna 150 includes a reader main antenna 151 and a tag sensing coil 152. The reader main antenna 151 transmits a TX signal of the RFID reader 100, or receives an RX signal from the RFID tag 200. The tag sensing coil 152 is disposed parallel to the reader main antenna 151 while being spaced apart from the main antenna 151 by a predetermined distance. If the tag sensing coil 152 has a larger diameter than the reader main antenna 151, a signal transmitted from the RFID tag 200 may fail to be normally received by the tag sensing coil 152. Thus, the tag sensing coil 152 is set to have a smaller diameter than the reader main antenna 151. The tag sensing coil 152 is connected to the tag sensor 160 shown in FIG. 1.

Referring to FIG. 2, when the RFID tag 200 does not enter the RF field, the antenna 150 operates as follows.

When a tag sensing signal is transmitted through the antenna 150, a current I flows through the reader main antenna 151 as illustrated in FIG. 2. The current I flowing through the reader main antenna 151 causes a magnetic field Ha to be created in the reader main antenna 151. The magnetic field Ha created in the reader main antenna 151 causes an induced current Ic to flow through the tag sensing coil 152. The induced current Ic flows in an opposite direction to the direction of current I flowing through the reader main antenna 151. The induced current Ic can be described by Faraday's Electromagnetic Induction Law and Lenz's Law.

Referring to FIG. 3, when the RFID tag 200 enters the RF field, the antenna 150 operates as follows.

The RFID tag 200 includes a tag antenna 201. When entering the RF field, the RFID tag 200 is enabled. The tag antenna 201 of the enabled RFID tag 200 creates a magnetic field Hb. The magnetic field Hb created in the tag antenna 201 of the RFID tag 200 reduces the magnitude of the magnetic field Ha created in the reader main antenna 151.

Because the magnitude of the magnetic field Ha created in the reader main antenna 151 is reduced, the induced current Ic created by the magnetic field Ha is reduced by an induced current Δi corresponding to a change in the magnetic field Ha. Thus, a current flowing through the tag sensing coil 152 becomes (Ic−Δi). The tag sensor 160 senses a current change in the tag sensing coil 152 that is caused by a magnetic field change in the reader main antenna 151. Specifically, the tag sensor 160 senses a current change in the tag sensing coil 152, and provides the sensing result to the controller 110. The subsequent operations are the same as described hereinabove.

The level of the tag sensing signal is not capable of communication between the RFID reader 100 and the RFID tag 200. When the RFID tag 200 enters the RF field, however, the RFID reader 100 senses the RFID tag 200 through the above-described configuration, thereby sensing that it is in a state capable of communicating with the RFID tag 200. Thereafter, the RFID reader 100 transmits a tag communication signal with a level capable of communication with the RFID tag 200, thereby communicating with the RFID tag 200.

As a result, even when transmitting the tag sensing signal having a lower level power than the tag communication signal, the RFID reader 100 can sense the RFID tag 200 through the tag sensing coil 152 of the antenna 150. Thus, the RFID system 1000 can reduce power consumption.

FIG. 4 is a diagram illustrating a tag sensing signal and a tag communication signal according to an exemplary embodiment of the present invention.

A region of a tag sensing signal and a tag communication signal illustrated in FIG. 4 is an effective period region. The effective period region defines the period during which a signal with a predetermined frequency is actually transmitted. FIG. 4 illustrates that a predetermined period of the tag sensing signal can be represented in the waveform of a signal with a predetermined frequency. For convenience in description, however, instead of being illustrated in the waveform of a specific signal, the tag sensing signal and the tag communication signal are simply labeled blocks of time forming an effective period region as illustrated in FIG. 4.

Referring to FIG. 4, the tag sensing signal is activated/deactivated periodically as shown by the labeled blocks. An active period illustrated in FIG. 4 is the period during which the transmitter 120 generates the tag sensing signal under the control of the controller 110. That is, the tag sensing signal is periodically generated as illustrated in FIG. 4. An inactive period illustrated in FIG. 4 is the period during which the transmitter 120 does not generate the tag sensing signal under the control of the controller 110 as shown by the spaces between the labeled blocks. That is, the transmitter 120 is disabled during the inactive period under the control of the controller 110 shown in FIG. 1.

Under the control of the controller 110, the tag sensor 160 is enabled during the active period to sense a current change in the antenna 150. Also, under the control of the controller 110, the tag sensor 160 is disabled during the inactive period.

As represented in FIG. 4, the tag sensing signal has a lower level power than the tag communication signal (tag communication power).

When the RFID tag 200 enters the RF field created by the antenna 150 and the tag sensing signal, the tag sensor 160 senses a current change due to a magnetic field change at the antenna 150, as described previously. The tag sensor 160 provides the sensing result to the controller 110. In response to the sensing result, the controller 110 controls the transmitter 120 to generate a tag communication signal (tag communication power). The generated tag communication signal (tag communication power) is transmitted through the antenna 150 to the RFID tag 200.

The tag communication signal (tag communication power) includes a reader request signal. In response to the reader request signal, the RFID tag 200 transmits a tag response signal to the RFID reader 100. The tag response signal transmitted from the RFID tag 200 is a tag communication signal (tag communication power). That is, signals for mutual communication between the RFID reader 100 and the RFID tag 200 are the reader request signal of the RFID reader 100 and the tag response signal of the RFID tag 200. Thus, the tag communication signal (tag communication power) includes the reader request signal and the tag response signal. The RFID reader 100 receives the tag response signal to obtain the information of the RFID tag 200.

As a result, when not communicating with the RFID tag 200, the RFID reader 100 transmits the tag sensing signal having a lower level power than the power level of the tag communication signal. Also, the transmitter 120 of the RFID reader 100 is disabled during the inactive period of the tag sensing signal. Thus, the RFID system 1000 can reduce power consumption.

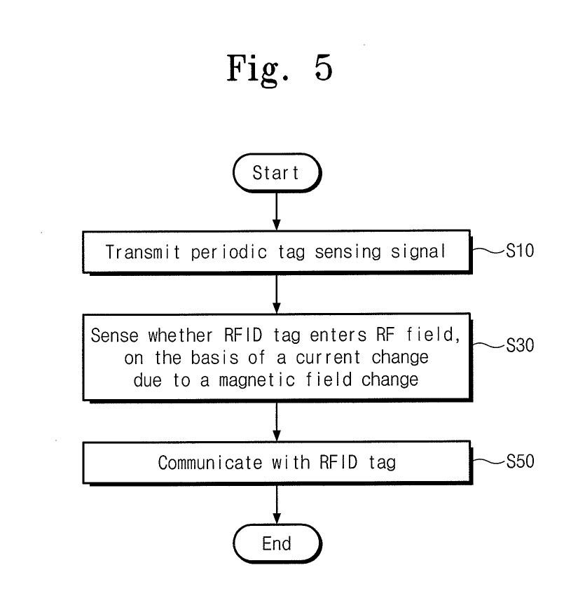

FIG. 5 is a flowchart illustrating an operation of the RFID system according to an exemplary embodiment of the present invention.

Referring to FIG. 5, in step S10, the RFID reader 100 generates a tag sensing signal periodically and transmits the periodically generated tag sensing signal.

When the RFID tag 200 enters the RF field created by the transmitted tag sensing signal, the tag sensor 160 of the RFID reader 100 senses the entry of the RFID tag 200 into the RF field on the basis of a current change due to a magnetic field change, in step S30. If the RFID tag 200 does not enter the RF field, that is, if the RFID tag 200 is not detected, the RFID reader 100 continues to generate the tag sensing signal periodically, that is, step S10 is sequentially repeated.

After the RFID tag 200 is detected, the RFID reader 100 communicates with the RFID tag 200, in step S50. Specifically, the RFID reader 100 transmits a reader request signal, shown in FIG. 4, to the RFID tag 200. In response to the reader request signal, the RFID tag 200 transmits a tag response signal, shown in FIG. 4, to the RFID reader 100. As a result, if the RFID tag 200 is detected, the RFID reader 100 communicates with the RFID tag 200, in step S50.

As described above, when not communicating with the RFID tag 200, the RFID reader 100 of the RFID system 1000 according to exemplary embodiments of the present invention transmits the tag sensing signal having a lower level power than the tag communication signal. Also, the transmitter 120 of the RFID reader 100 is disabled during the inactive period of the tag sensing signal. Thus, the RFID system 1000 can reduce power consumption.

The above-disclosed subject matter is to be considered illustrative, and not restrictive, and the appended claims are intended to cover all such modifications, enhancements, and other exemplary embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A radio frequency identification (RFID) system comprising:
an RFID tag; and
an RFID reader communicating with the RFID tag through a tag communication signal,
wherein the RFID reader transmits a tag sensing signal having a lower level power than the tag communication signal, senses the RFID tag entering a magnetic field created by the transmitted tag sensing signal on the basis of a current change due to a change in the magnetic field caused by the RFID tag, and communicates with the sensed RFID tag.

2. The RFID system of claim 1, wherein the tag sensing signal is activated/deactivated periodically, and the tag communication signal comprises a reader request signal and a tag response signal.

3. The RFID system of claim 2, wherein the RFID reader senses the RFID tag and then transmits the reader request signal to the RFID tag.

4. The RFID system of claim 3, wherein the RFID tag transmits the tag response signal to the RFID reader in response to the reader request signal transmitted from the RFID reader.

5. The RFID system of claim 2, wherein the RFID reader comprises:
a controller controlling a transmitting/receiving operation;
a transmitter generating the tag sensing signal or the reader request signal under the control of the controller;
an antenna transmitting the tag sensing signal and the reader request signal;
a receiver providing the controller with the tag response signal received through the antenna; and
a tag sensor sensing the entry of the RFID tag into the RF field on the basis of a current change due to a change in the magnetic field at the antenna,
wherein the controller controls the transmitter to generate the tag sensing signal or the reader request signal, according to the sensing result of the tag sensor.

6. The RFID system of claim 5, wherein the transmitter is disabled during an inactive period of the tag sensing signal under the control of the controller.

7. The RFID system of claim 5, wherein when the RFID tag does not enter the RF field, the controller controls the transmitter to generate the tag sensing signal, in response to the sensing result of the tag sensor.

8. The RFID system of claim 5, wherein when the RFID tag enters the RF field, the controller controls the transmitter to generate the reader request signal, in response to the sensing result of the tag sensor.

9. The RFID system of claim 5, wherein the antenna comprises:
a reader main antenna transmitting the tag sensing signal or transmitting/receiving the tag communication signal; and
a tag sensing coil disposed parallel to the reader main antenna and being spaced apart from the reader main antenna by a predetermined distance,
wherein the reader main antenna creates a magnetic field at the transmission of the tag sensing signal, and the created magnetic field causes an induced current to flow through the tag sensing coil.

10. The RFID system of claim 9, wherein the tag sensing coil has a smaller diameter than a diameter of the reader main antenna.

11. The RFID system of claim 9, wherein the RFID tag comprises a tag antenna, and a magnetic field created in the reader main antenna is reduced by a magnetic field created in the tag antenna, when the RFID tag enters the RF field.

12. The RFID system of claim 11, wherein the induced current flowing through the tag sensing coil is reduced by a current amount corresponding to the magnetic field reduction, and the tag sensor senses the reduction in the amount of the induced current flowing through the tag sensing coil.

13. A method for operating a radio frequency identification (RFID) system, comprising:
transmitting a tag sensing signal having a lower level than a tag communication signal;
sensing an RFID tag entering a magnetic field created by the transmitted tag sensing signal, on the basis of a current change due to a change in the magnetic field; and
communicating with the sensed RFID tag.

14. The method of claim 13, wherein the tag sensing signal is activated/deactivated periodically.

15. A radio Frequency identification (RFID) system comprising:
an RFID tag; and
an RFID reader communicating with the RFID tag through a tag communication signal, and including
a controller controlling a transmitting/receiving operation;
a transmitter generating a tag sensing signal or a reader request signal under the control of the controller;
an antenna transmitting the tag sensing signal and the reader request signal;
a receiver providing the controller with the tag response signal received through the antenna; and
a tag sensor sensing the entry of the RFID tag into a magnetic field created by the antenna on the basis of a current change due to a change in the magnetic field at the antenna,
wherein the controller controls the transmitter to generate the tag sensing signal or the reader request signal, according to the sensing result of the tag sensor.

16. The RFID system of claim 15, wherein the antenna comprises:
a reader main antenna transmitting the tag sensing signal or transmitting/receiving the tag communication signal; and
a tag sensing coil disposed parallel to the reader main antenna and being spaced apart from the reader main antenna by a predetermined distance,
wherein the reader main antenna creates a magnetic field at the transmission of the tag sensing signal, and the created magnetic field causes an induced current to flow through the tag sensing coil.

17. The RFID system of claim 15, wherein the tag sensing coil has a smaller diameter than the reader main antenna.

18. The RFID system of claim 15, wherein the RFID tag comprises a tag antenna, and a magnetic field created in the reader main antenna is reduced by a magnetic field created in the tag antenna, when the RFID tag enters the RF field.

19. The RFID system of claim 18, wherein the induced current flowing through the tag sensing coil is reduced by a current amount corresponding to the magnetic field reduction, and the tag sensor senses the reduction in the amount of the induced current flowing through the tag sensing coil.

20. The RFID system of claim 15, wherein the tag sensing signal is activated/deactivated periodically, and the tag communication signal comprises a reader request signal and a tag response signal.
